(19) United States
(12) Patent Application Publication
(10) Pub. No.: US 2026/0185717 A1
(43) Pub. Date: Jul. 2, 2026

(54) CONTROL OPERATING SYSTEM OF A GAS COOKING APPLIANCE

(71) Applicant: BSH Hausgeräte GmbH, Munich (DE)

(72) Inventors: Alvaro Martinez Diez, Peñacastillo (Santander) (ES); Manuel Alejandro Ruiloba Franco, Cóbreces, Cantabria (ES)

(21) Appl. No.: 19/131,339

(22) PCT Filed: Dec. 18, 2023
(86) PCT No.: PCT/EP2023/086307

§ 371 Date: May 20, 2025

(30) Foreign Application Priority Data
Dec. 22, 2022 (EP) 22383263.5

(51) Int. Cl. F24C 3/12; G05G 1/08; G05G 25/04

(52) U.S. Cl. CPC F24C 3/124; G05G 1/08; G05G 25/04

(57) ABSTRACT

A control operating system of a gas cooking appliance includes a control panel with an opening for letting through a control shaft of a gas tap arranged behind the control panel, an operating element having a connecting part with a shaft connected to the control shaft of the gas tap and an actuating part with a front area and a skirt extending from the front area in the direction towards the control panel around the shaft. An elastic sealing gasket is arranged at the perimeter of the opening and has a neck projecting towards the operating element inside the skirt around the shaft. A detachable connecting system connects a cap to the operating element and includes a positive-fit connecting element such that the cap is connectable to and thereby entirely covers the operating element, so that the control shaft of the gas tap is actuated when the cap is actuated.

The invention relates to a control operating system of a gas cooking appliance having a control panel with at least an opening for letting through a control shaft of a gas tap arranged behind the control panel, an operating element having a connecting part with a shaft connected to the control shaft of the gas tap to actuate it and an actuating part with a front area and a skirt extending from the front area in the direction towards the control panel around the shaft, wherein the control operating system also has an elastic sealing gasket arranged at the perimeter of the opening, which has a neck projecting towards the operating element inside the skirt around the shaft.

Control operating systems of gas cooking appliances are known in which the operating element is made in such a manner that it is connectable to the control shaft of the gas tap to control the gas tap and can be demounted to facilitate the cleaning of the top plate of the gas appliance. Furthermore, these systems have a sealing gasket arranged at the orifice of the top plate through which the control shaft of the gas tap extends to avoid or reduce the penetration of dirt into the appliance.

The object of the invention consists in particular in providing an improved control operating system regarding the safety of the gas cooking appliance in which it is installed. According to the invention, this object is achieved by means of the features of claim 1, while advantageous configurations and developments of the invention can be derived from the dependent claims.

The invention relates to a control operating system of a gas cooking appliance having a control panel with at least an opening for letting through a control shaft of a gas tap arranged behind the control panel, an operating element having a connecting part with a shaft connected to the control shaft of the gas tap to actuate it and an actuating part with a front area and a skirt extending from the front area in the direction towards the control panel around the shaft, wherein the control operating system also has an elastic sealing gasket arranged at the perimeter of the opening, which has a neck projecting towards the operating element inside the skirt around the shaft. The control operating system comprises at least a cap and at least a detachable connecting system between the cap and the operating element, which has at least a positive-fit connecting element in such a manner that the cap is connectable to the operating element, the operating element being thereby entirely covered, so that the control shaft of the gas tap is actuated when the cap is actuated.

The gas cooking appliance may be a gas hob in which the control panel with the operating elements is a part of the horizontal supporting plate where the gas burners are located or of the type of a gas stove in which the control panel is arranged vertically on the appliance front. The interior of the gas cooking appliance is delimited by a housing and the supporting plate, which can be made of glass, metal or the like. Gas pipes leading gas from the collecting pipe to the gas tap and from the tap to the gas burner are arranged inside the appliance. And the gas tap is controlled with a shaft extending through the control panel by means of the operating element. The operating element needs to be ergonomic to be held by the user and rotated by applying a force on the shaft of the gas tap. The operating element has a connecting part and an actuating part. With the connecting part, the operating element is joined to the shaft of the gas tap. The actuating part, which can be joined in one piece to the connecting part, is the own body of the operating element, which can be handled by the user and has an overall external shape composed of a front area, when it is observed in the direction of the shaft of the gas tap, and a skirt extending from the front area towards the control panel around the shaft.

In this type of gas cooking appliance, operating elements need to be designed in compliance with the safety rules in force. Therefore, they must be approved following the requirements imposed by the rule. Thus, if a modification of the aesthetical appearance of the appliance is intended by changing the operating elements, the new operating elements need to be approved as well and, for this reason, the costs increase. To reduce the cost of the control operating system of the household appliance, a cap is provided, which can be connected to the operating element by means of a connecting system.

It is provided that the connecting system is detachable to be so able to interchange different caps with the operating element if needed. The connecting system between the cap and the operating element has positive-fit connecting elements. In a preferred embodiment, at least a part of the connecting system is arranged between the skirt and the cap skirt, preferably the connecting system is arranged between the skirt and the cap skirt. And in another feasible embodiment, at least a part of or the entire connecting system is arranged between the front area and the cap inner area.

With the connecting system, the cap remains fixedly connected to the operating element without any relative movement between them, thereby forming an operating unit, so that, when the cap is handled, the shaft of the gas tap is handled directly. In this manner, if a new aesthetics of the appliance is wanted, no new operating element needing to be approved is required, since the operating element is still the same one and, just by changing the cap, the external shape itself changes. This reduces costs but also gives versatility to the aesthetical change of the appliance, since the cap has a cap inner area inside the cap and a cap skirt surrounding the skirt of the operating element when the cap is mounted on the operating element. Furthermore, the positive-fit connecting elements are arranged between the front area of the operating element and the cap inner area in such a manner that, when the cap is rotated by the user about the rotation axis, it in turn pulls and rotates the operating element. To ensure the correct position of the cap on the operating element, it is provided that the positive-fit connecting elements between the front area and the cap inner area have a poka-yoke fitting function. However, to facilitate the separation of the cap and the operating element, the positive-fit connecting elements do not limit the connection between the cap and the operating element in the direction of the control shaft. This means that the positive-fit connecting elements do not limit the linear extracting movement of the cap in the direction away from the operating element, but do limit the rotational movement. To limit the separating movement between the operating element and the cap, it is provided that the detachable connecting system between the cap and the operating element has magnetic connecting elements forcing the connection between the cap and the operating element in the direction of the control shaft, thereby exerting a force of attraction between the two. This force of attraction is strong enough to attract them but not to avoid their separation by a force exerted by a user with no tools.

The control operating system also has a sealing gasket arranged at the perimeter of the opening preventing liquids or dirt spilt over the top surface of the plate of the gas cooking appliance from flowing through it, wherein the sealing gasket has a neck projecting towards the operating element inside the skirt around the shaft. In this manner, the safety of the appliance is increased since a sealing gasket with a neck extending in this way provides a spill safe closing of the opening. In a preferred embodiment, the end of the neck is always in contact with the operating element around the shaft even when the gas cooking appliance is not being used. Preferably, the interference between the neck and the operating element is achieved when the neck of the gasket has a length exceeding by 0.5 mm the distance to the operating element and, more preferably, exceeding by 1 mm. In this manner, if a liquid spill occurs at any time, the opening is completely sealed by the sealing gasket and the operating element.

In a preferred embodiment, the size of the operating element is smaller than the size of the opening. When it is stated that the size of the operating element is smaller than the size of the opening, it makes reference to the fact that the area of the opening is bigger than the biggest section of the operating element over a plane parallel to the plane of the opening, this being preferably 10% smaller, more preferably 30% smaller, and more advantageously 50% smaller than the area of the opening. This configuration is very advantageous since a small operating element does not hinder access to the top surface of the control panel to clean it and even allows access to the greatest part of the sealing gasket if required. Furthermore, the operating elements being smaller than the opening, the elastic sealing gasket can be disconnected from the opening perimeter to access the gas tap if needed. And, even further, if it was required, the supporting plate could be removed from the gas cooking appliance without the removal of the operating elements being necessary since these could extend through the opening of the control panel. With a very small operating element, for example with an operating element section 50% smaller than the opening area, the cleaning of the appliance is facilitated to a great extent since, when the cap is removed from the operating element, the entire surface of the control panel remains free up to the own opening and even a part of the sealing gasket. And, although the operating element is small relative to the opening, an essential advantage is that the gas cooking appliance can be operated by the user even without the cap connected to the operating element since the gas tap can be actuated without any problems by means of the small operating element.

In another very interesting embodiment, it is provided that the operating element is detachable with a tool. ‘Detachable with a tool’ means that it cannot be removed with a normal force exerted by hand and, specifically, a force specified in the Standard. This is important to improve the safety of the control operating system and of the gas cooking appliance since, with an operating element that can be removed only with a tool, the risk of the same to be separated from the appliance by an unskilled user is reduced and it may even happen that a warning stating that the operating element is not detachable and only the cap can be separated is included in the user manual. In this manner, it would only be convenient that a technical service operator could remove it to repair the appliance due any failure. With this configuration, in addition, while the operating element cannot be detached, the sealing gasket would always be arranged in its position and the neck of the gasket around the shaft and surrounded by the skirt of the operating element, and it would avoid much better the penetration of dirt or even cleaning products while cleaning the appliance.

To facilitate the control of the gas cooking appliance to the user, it is provided that the front area of the operating element has a grabbing area to facilitate the grabbing of the operating element, while the cap may have or not a cap grabbing area covering the grabbing area. This is relevant if it is intended to change the appearance of the appliance's control in a more or less evident manner. In this case, it is also provided that the connecting system is arranged, at least in part or entirely, between the grabbing area and the cap grabbing area.

In addition, it is provided that the operating element is made of just one plastic piece, with the connecting and actuating part being injected or shaped in the same process and with the possibility to have an embellishing or functional coating, which can be also applied in the same injection process or later. The functional coating can be autonomously illuminated such as by luminescence or have antibacterial properties or be electrically conductive being adaptable to particular functionalities of the appliance. This is also applicable to the cap. Furthermore, the operating element can have a light guide or be a light guide itself to lead the light emitted by an external source or by the coating to a particular location of the operating element. The cap can have a passage for light guide, so that light emitted by the operating element can be seen through the passage for light guide in the cap.

In another aspect of the invention, a cap is provided fitting with the operating element of the control operating system of the invention, and another aspect relates to the set of the gas cooking appliance with at least a cap connectable to the operating element or elements of the appliance.

Other advantages derive from the following description of the drawing. An exemplary embodiment of the invention is represented in the figures. The figures, the description and the patent claims contain combinable features.

The figures show:

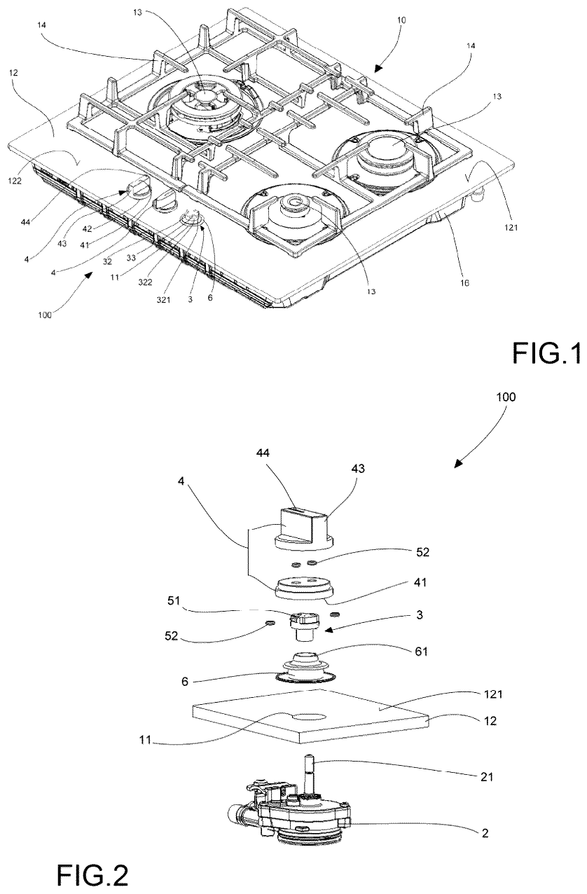

FIG. 1 a perspective view of the gas cooking appliance with the control operating system of the invention,

FIG. 2 an exploded view of the control operating system of the invention,

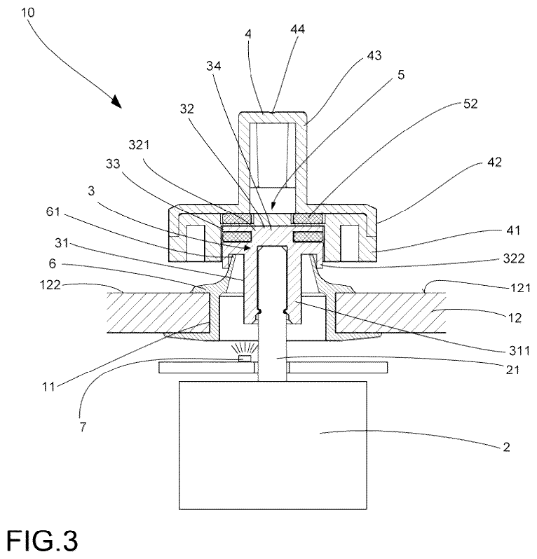

FIG. 3 a section of the control operating system of the invention,

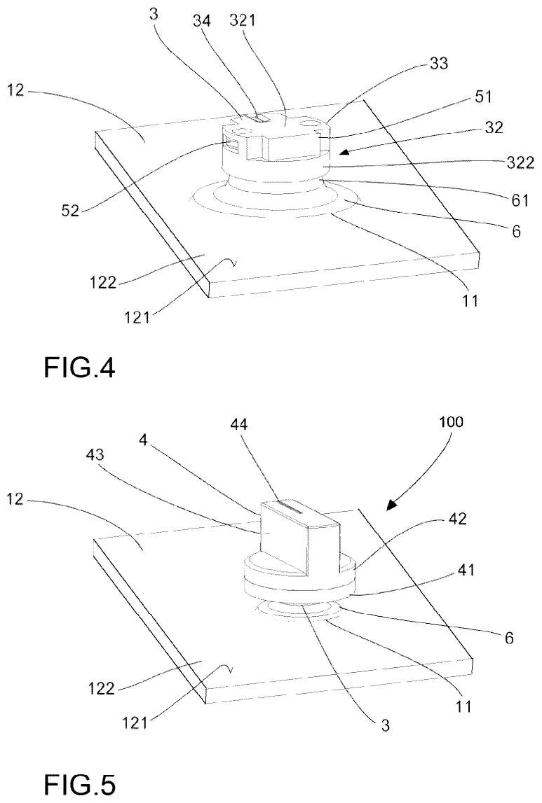

FIG. 4 a perspective view of an operating element in a working position, and

FIG. 5 a perspective view of the control operating system of the invention.

A gas cooking appliance 10 like the one shown in FIG. 1 has an appliance housing 16 and a supporting plate 12 made of tempered glass in this case but which can be made of metal, a ceramic material or the like. The supporting plate 12 is rectangular and, in an area close to the perimeter of one of its sides, there is a control panel 122 on which three operating units with three operating elements 3 are arranged to control the gas taps 2 (not visible) controlling the gas and flame flow in the three gas burners 13. The gas burners 13 rest on the top surface 121 of the supporting plate 12. The two pan supports 14 also rest detachably on the top surface 121 of the supporting plate 12 and extending over the gas burners 13. In this case, the two pan supports 14 cover an almost identical area of the supporting surface but the left one is arranged on one gas burner 13 and the right pan support 14 covers two gas burners 13. The burner's pan supports 14 can be independent for one gas burner 13 or cover more than one gas burner 13.

All the gas conduits required to lead the gas from outside the gas cooking appliance 10 through the internal pipes up to the gas burners 13, flowing through the gas taps 2, are arranged inside the gas cooking appliance 10 defined by the supporting plate 12 and the appliance housing 16. Each gas tap 2 has a control shaft 21 extending through a corresponding opening 11 in the control panel 122. The operating elements 3 are press-fitted on each control shaft 21 of each gas tap 2 by means of their connecting part 31 and can be handled by the user since they can be grabbed at their actuating part 32. The actuating part 32 has a front area 321 with a grabbing area 33 and a skirt 322 extending towards the control panel 122 around the connecting part 31 and the control shaft 21 of the gas tap 2. The operating element 3 is made of a translucent plastic, so the operating element 3 is also a light guide 34 in such a manner that it can lead light through its entire structure and, when the cap 4 is placed on the operating element 3, light can flow through the passage for light guide 44 apart from emitting light from the operating element 3 towards the sealing gasket 6.

On the leftmost operating element 3 of the gas cooking appliance 10, and forming an operating unit, a cap 4 is connected having a cap front area 41 with a cap grabbing area 43 and a cap skirt 42 extending towards the control panel 122 around the control shaft 21 of the gas tap 2. On the top face of the cap grabbing area 43, there is a passage for light guide 44 letting through the illumination emitted by the light guide 34 of the operating element 3 covered by it. The operating unit arranged in the centre has a cap 4 on the operating element 3 having a different appearance from the cap 4 of the left operating unit. The operating element 3 is not covered by any cap on the right one of the three.

FIG. 2 shows an exploded perspective of the control operating system 100 with a gas valve or gas tap 2 having a control shaft 21 of the gas tap 2 under the control panel 122 of the supporting plate 12. The sealing gasket 6 with its gasket neck 61 is above the top surface 121 of the supporting plate 12. The operating element 3 with its positive-fit connecting elements 51 and its magnetic connecting elements 52 are arranged further up and, on this, the cap 4 formed by the cap inner area 41 and the cap grabbing area 43 having other magnetic connecting elements 52 of the connecting system 5.

FIG. 3 shows a section of the supporting plate 12 in the area of the control panel 122 at the level of the leftmost operating unit in FIG. 1 formed by the operating element 3 and the cap 4. The gas tap 2 is arranged on one side of the control panel 122 inside the gas cooking appliance 10. The gas tap 2 is controlled with a control shaft 21 extending through the control panel 122 through the opening 11. The operating element 3 is connected to the control shaft 21 by means of a shaft 311, which is a part of the connecting part 31. Over the gas tap 2, there is a control board with a light source 7 emitting towards the shaft 311 of the connecting part 31 of the operating element 3. In this embodiment of the invention, the entire operating element 3 is a light guide 34, although the light guide could be made as a part of the operating element 3.

The connecting part 31 is joined in one piece to the actuating part 32 having a front area 321 with a grabbing area 33 allowing the grabbing of the operating element 3 to the user. The skirt 322 surrounding the shaft 311 of the connecting part 31 extends from the front area 321. The sealing gasket 6, which is made of an elastic material, is inserted into the perimeter of the opening 11, thereby sealing it completely. The sealing gasket 6 extends with a gasket neck 61 towards the shaft 311 and into the skirt 322 of the operating element 3 and remains in contact with this. The neck 61 is so thin that, when the operating element 3 is displaced towards the gas tap 2, it bends without losing contact with the operating element 3.

The actuating part 32 has magnetic connecting elements 52 forming part of the connecting system 5 between the operating element 3 and the cap 4. In this case, the magnetic connecting elements 52 are made as permanent magnets arranged in the actuating part 32 of the operating element 3 and by reverse pole permanent magnets arranged in the cap 4. However, magnets and ferromagnetic elements attracted by the magnets or any combination of them can also be used. With permanent magnets having the same pole, a poka-yoke function can be performed as well to avoid placing the cap 4 in a wrong position on the operating element 3. The positive-fit connecting elements 51 are also present in the actuating part 32, which cannot be seen in this figure and are geometrical shapes fitting into the cap inner area 41.

The cap 4 is connected on the operating element 3, with its cap inner area 41 fitting with the positive-fit connecting elements 51 of the operating element 3. The cap 4 also has a cap grabbing area 43 on its front from which the cap skirt 42 surrounding the skirt 322 of the operating element 3 extends towards the top surface 121 of the control panel 122. As it has been previously explained, the connecting elements 51 and 52 of the connecting system 5 are present in the cap 4 complementing the operating element 3. On the top face of the cap front area 43, there is a passage for light guide 44 through which the light emitted by the light guide 34 of the operating element 3 flows.

FIG. 4 shows a perspective view of an operating element 3 mounted on the control shaft 21 of the gas tap 2 of the gas cooking appliance 10. There is an opening 11 having a perimeter into which the sealing gasket 6 is fitted in the control panel 122 of the supporting plate 12. The sealing gasket 6 has a neck 61 extending upwards above the top surface 121 of the supporting plate 12. The operating element 3 is made in one piece of translucent plastic having a connecting part 31 with a shaft 311 and an actuating part 32 with a front area 321 in which there is a grabbing area 33 and a skirt 322 extending around the shaft 311 of the connecting part 31 of the operating element 3 (not seen in the figure). The neck 61 of the sealing gasket 6 is inserted between the skirt 322 and the shaft 311 of the operating element 3. The magnetic connecting elements 52 and the positive-fit connecting elements 51 of the connecting system 5 corresponding to the operating element 3 are arranged in the connecting part 31. The magnetic connecting elements 52 are made as two disc-shaped permanent magnets, which are inserted into side notches made for this purpose in the actuating part 32 of the operating element 3. The positive-fit connecting elements 51 are made as stepped cut-outs of the perimeter of the actuating part 32. The connecting elements 51, 52 of the connecting system 5 cooperating with those of the operating element 3 seen in FIG. 4 are present in the cap 4 (not present in the figure). On the top face of the grabbing area 33 of the operating element 3, there is a light guide 34 through which light generated either by a luminescent coating on the surface of the light guide 34 or by an external source of illumination channelling it up to the light guide 34 is emitted.

FIG. 5 shows a perspective view of the control operating system 100 in which the cap 4 is connected to the operating element 3 from FIG. 4, thereby forming the operating unit. The cap 4 has a cap inner area 41 connected by means of the connecting system 5 to the operating element 3, a cap grabbing area 43 and a cap skirt 42. On the top face of the cap grabbing area 43, there is a passage for light guide 44 through which light coming from the light guide 34 of the operating element 3 can flow.

### REFERENCE NUMERALS

10 gas cooking appliance

11 opening

12 supporting plate

121 top surface

122 control panel

13 gas burner

14 pan support

16 appliance housing

2 gas tap

21 control shaft

3 operating element

31 connecting part

311 shaft

32 actuating part

321 front area

322 skirt

33 grabbing area

34 light guide

4 cap

41 cap inner area

42 cap skirt

43 cap grabbing area

44 passage for light guide

5 connecting system

51 positive-fit connecting element

52 magnetic connecting element

6 sealing gasket

61 neck

7 light source

100 control operating system

1-14. (canceled)

15. A control operating system of a gas cooking appliance, the control operating system comprising:
a control panel having an opening for letting through a control shaft of a gas tap arranged behind the control panel;
an operating element comprising a connecting part with a shaft connected to the control shaft of the gas tap to actuate the gas tap, and an actuating part including a front area and a skirt extending from the front area in a direction towards the control panel around the shaft;
an elastic sealing gasket arranged at a perimeter of the opening and comprising a neck projecting towards the operating element inside the skirt around the shaft;
a cap; and
a detachable connecting system between the cap and the operating element, said connecting system comprising a positive-fit connecting element designed in such a manner that the cap is connectable to the operating element, with the operating element being thereby entirely covered, so that the control shaft of the gas tap is actuated when the cap is actuated.

16. The control operating system according to claim 15, wherein the operating element has a size which is smaller than a size of the opening.

17. The control operating system according to claim 15, wherein the operating element is detachable with a tool.

18. The control operating system according to claim 15, wherein the cap has a cap inner area in contact with the front area and a cap skirt surrounding the skirt of the actuating part when the cap is mounted on the operating element.

19. The control operating system according to claim 18, wherein the positive-fit connecting element is located between the front area of the operating element and the cap inner area of the cap in such a manner that, when the cap is rotated by the user about a rotation axis defined by the control shaft, the cap pulls and rotates the operating element.

20. The control operating system according to claim 15, wherein the positive-fit connecting element has a poka-yoke fitting function.

21. The control operating system according to claim 15, wherein the positive-fit connecting element is designed to not limit a connection between the cap and the operating element in a direction of the control shaft so as to permit separation of the cap and the operating element.

22. The control operating system according to claim 15, wherein the detachable connecting system between the cap and the operating element comprises magnetic connecting elements forcing a connection between the cap and the operating element in a direction of the control shaft, thereby exerting a force of attraction between the cap and the operating element.

23. The control operating system according to claim 15, wherein the front area of the actuating part of the operating element includes a grabbing area to facilitate a grabbing of the operating element, said cap including a cap grabbing area covering the grabbing area.

24. The control operating system according to claim 15, wherein the neck of the sealing gasket has an end, which is in contact with the operating element.

25. The control operating system according to claim 15, wherein the operating element is made in one piece of plastic and capable of having a light guide.

26. The control operating system according to claim 15, wherein the cap has a passage for a light guide for light coming from the light guide.

27. A cap for the control operating system of claim 15, the cap comprising:
a cap front area including a cap grabbing area having a passage of light emitted by a light guide; and
a cap skirt extending from the cap front area towards the control panel of the control operating system

28. A set, comprising:
a gas cooking appliance comprising a control operating system which comprises a control panel having an opening for letting through a control shaft of a gas tap arranged behind the control panel, an operating element comprising a connecting part with a shaft connected to the control shaft of the gas tap to actuate the gas tap and an actuating part including a front area and a skirt extending from the front area in a direction towards the control panel around the shaft, and an elastic sealing gasket arranged at a perimeter of the opening and comprising a neck projecting towards the operating element inside the skirt around the shaft; and
a cap connectable to the operating element in such a manner that the operating element is entirely covered, so that the control shaft of the gas tap is actuated when the cap is actuated, said cap comprising a cap front area including a cap grabbing area having a passage of light emitted by a light guide, and a cap skirt extending from the cap front area towards the control panel of the control operating system around the control shaft of the gas tap.
